(19) United States
(12) Patent Application Publication
(10) Pub. No.: US 2004/0262799 A1
(43) Pub. Date: Dec. 30, 2004

(54) Method of controlling an ejection molding process of an ejection molding machine

(76) Inventor: Jui-Hsiang Wang, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/601,587

(22) Filed: Jun. 24, 2003

(51) Int. Cl. B29C 45/76

(52) U.S. Cl. 264/40.1; 264/328.1

(57) ABSTRACT

A method of controlling an ejection molding process of an ejection molding machine includes the action of setting an automatic process, which is done right after the action of setting function/time, and by means of which those motions are set that are to be performed between completion of the mold-opening action and completion of the mold-closing action by means of choosing among prepared options provided for setting each motion according to the nature of the mold used on the injection molding machine as well as the form of the products to be made with the machine and the mold.

### BACKGROUND OF THE INVENTION

1. Field of the Invention

The present invention relates to a method of controlling an ejection molding process of an ejection molding machine, more particularly, in which a program and a control panel are adopted, and with which a user can conveniently and easily set motions, speed, and temperature of various parts of both an ejection molding machine and a mold at different stages of a molding process by means of choosing appropriate ones among options, which have been made ready in the program and presentable on the control panel, according to the nature and characteristics of the mold; manufacturers or designers won't be afraid any more that characteristics, and commercial secrets and exclusive advanced technology relating to their mold might be revealed because with the present method, they now can set parameters of various parts of the machine and the mold at different stages of a molding process by themselves without having to entrust the setting to the manufacturer of the molding machine.

2. Brief Description of the Prior Art

Performance of an injection molding machine largely depends on control of various parts of the machine and the mold, e.g. mold closing, motion of the support base of the male mold part, injection of materials into the mold, feeding of materials, backward motion of the material feeding screw rod, mold opening, separating the molded product from the mold, etc., and smoothness of control of the various parts will result in good quality of products and high productivity of the machine.

A flow chart of a conventional method of setting a bi-color injection molding process to control an injection molding machine is shown in FIG. 3. Setting is done with a control panel and by means of inputting appropriate parameters and settings related to operation of the injection molding machine and motion of the mold so that the machine works accordingly afterwards. And, followings are the major windows to be showed on the control panel in setting operation of the machine and the mold:

1. machine status, which provides information related to operation of the machine, only provided for the user to monitor the operation, and not to be used for setting;

2. temperature setting, as shown in FIG. 5, in which various options for setting temperature and heating step in the injection molding process are provided, e.g. heating (YES/NO), maintaining the temperature, automatic heating, and maintaining the temperature automatically;

3. clamp setting, as shown in FIG. 6, which includes three columns: mold closing, mold opening, and mold adjusting; each column has several spaces shown thereon for input of relevant settings, e.g. model number of the currently used mold, item number of the first and the second materials, the time span between beginning of movement of the movable male mold part and completion of mold closing, the time span between the mold part beginning passing through low pressure protection zone and the mold part finishing passing through high pressure mold-closing zone, the time span between beginning of mold-opening (beginning of movement of the male mold part) and completion of mold-opening, and position of the mold; in addition, direction of the mold parts are also shown for allowing adjustment of the mold parts;

4. front injection/charging setting, as shown in FIG. 7, which includes four columns: injection, maintaining the pressure, material feeding, and ACC accumulator; there are several relevant options provided for setting for each column, e.g. real-time position indication of the material feeding screw rod; the actions of injection, feeding, backward movement of the screw rod, backward movement of the support base of the male mold part, and forward movement of the support base of the male mold part will be carried out in sequence only when “input” key of the control panel is pressed and “on” is chosen, and will not be carried out otherwise; there are several options provided for setting of injection-related matters such as protection of injection, protection of material feeding, and time for cooling;

5. pushing/blowing setting, as shown in FIG. 8, which has six options provided for setting, which are “middle ejector pushing out the molded product”, “the support base of the male mold part rotating”, “front ejector pushing out the molded product”, “rear ejector pushing out the molded product”, “air blowing the molded product off”, and “other functions”, such that positions of the ejectors and the movable male mold part can be known, and the actions of the middle ejector, the front ejector, and the rear ejector, and the blowing function have respective windows for further detailed setting thereof;

6. function/time setting, as shown in FIG. 9, which includes three columns for settings of “function switch”, “initial pressure on the front side and the rear side”, and “time” respectively; the setting of function switch relates to various motions and functions in injection molding process; the setting of initial pressure on the front side and the rear side relates to initial pressure, and motions of the valves; the setting of time relates to timing and numbers of times of protective actions, and delays;

7. product information, as shown in FIG. 10, which includes two columns for managing data of production, and for setting of the standard (parameters) of quality control of the molded products respectively; the data of production relate to time used in production, and quantity of products;

8. file management, which allows the operator of the machine to store and manage parameters about formation of products;

9. core setting, as shown in FIG. 11, which includes three columns for settings of the first core, the second core, and the gate valve respectively, so that motion and position of the cores and the gate valve can be controlled;

10. auto purge/carriage, as shown in FIG. 12, which are provided for choosing among the materials to be purged, and for settings of motions of the carriage, injection, and charging of materials;

11. backward injection/charging, as shown in FIG. 13, which includes four columns for settings of injection, pressure maintenance, material charging, and the use of ACC respectively; whereby the operator can monitor real-time position of the rear screw rod, rotational speed of the screw rod in charging, injection/charging/backward movement of the screw rod/backward movement of the carriage/forward movement of the carriage, the length of time of protection during injection, the length of time of protection during charging, the length of time during cooling, and can divide injection into several stages for easier control; pressure, speed, and time can be set for each of the pressure maintenances of different stages so that the machine can work according to the settings and other settings such as form of injection, choice of oil cylinders, and whether to use an accumulator or not; charging of materials is also divided into several stages each being capable of being set with appropriate options.

The above method allows the user of an injection molding machine to set basic operations of the machine. However, the above method doesn't contain a function of setting that has to be done every time a different mold is used on the molding machine instead of the original one; every time a different mold is used on the molding machine for producing different products, the manufacturer has to have the controlling method changed and set to a new one. Therefore, the above method can't meet the need of manufacturers of products of injection molding because the current trend is towards small quantity but large variety of products to meet the need of consumers. The user of the molding machine usually has to request the manufacturer of the molding machine to send engineers to their factory to understand the nature and characteristics of a new mold as well as form of products to be made with the new mold so that the engineers can set an appropriate control method for the new mold.

Consequently, it will cost the user of the molding machine relatively much money, time, and labor to change a new mold on the machine. In other words, the above method is not economical and convenient. Furthermore, the user of the molding machine has to be worried that characteristics, and commercial secrets and exclusive advanced technology relating to his mold might be revealed when engineers of other companies are doing the setting and change for his machine.

### SUMMARY OF THE INVENTION

It is a main object of the present invention to provide a method of controlling an ejection molding process of an ejection molding machine, with which a user can easily set motions, speed, and temperature of various parts of both an ejection molding machine and a mold used on the machine at different stages of a molding process according to the nature and characteristics of the mold.

The method of the present invention includes the action of setting an automatic process, which is done right after the action of setting function/time, and which includes a first part whereby those motions can be set that are to be performed after completion of the mold-opening action by means of choosing among prepared options provided for setting each motion according to nature of the mold, and a second part whereby those motions can be set that are to be performed after completion of the mold-closing action by means of choosing among prepared options for setting each motion according to nature of the mold.

### BRIEF DESCRIPTION OF THE DRAWINGS

The present invention will be better understood by referring to the accompanying drawings, wherein:

FIG. 1 is a flow chart of the method of controlling an ejection molding process according to the present invention,

FIG. 2 is the window for setting the auto process of the present method,

FIG. 3 is a flow chart of the conventional method of controlling an ejection molding process as described in the Background,

FIG. 4 is a window for monitoring machine status in the conventional method,

FIG. 5 is a window for setting temperature in the conventional method,

FIG. 6 is a window for setting clamp in the conventional method,

FIG. 7 is a window for setting forward injection/charging in the conventional method,

FIG. 8 is a window for setting eject/blowing in the conventional method,

FIG. 9 is a window for setting function/time in the conventional method,

FIG. 10 is a window for managing information of production in the conventional method,

FIG. 11 is a window for setting cores in the conventional method,

FIG. 12 is a window for setting auto purging/carriage in the conventional method, and

FIG. 13 is a window for setting backward injection/charging in the conventional method.

### DETAILED DESCRIPTION OF THE PREFERRED EMBODIMENTS

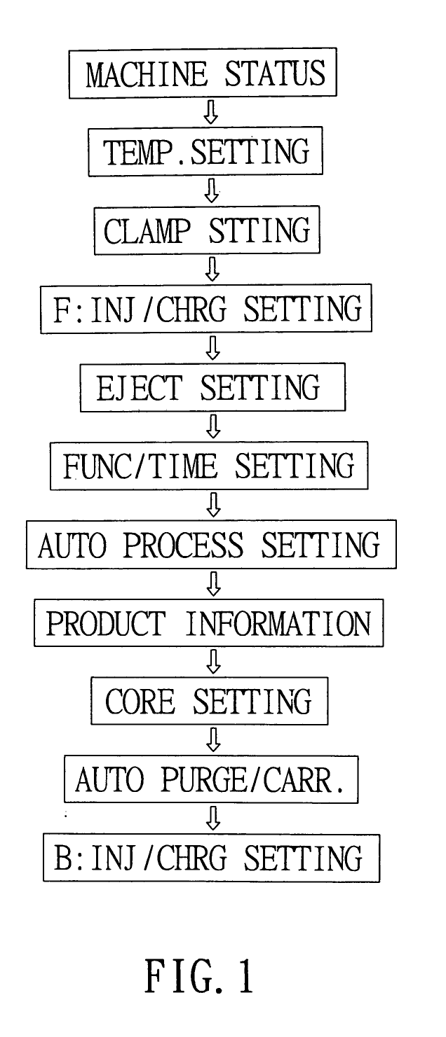

Referring to FIG. 1, a preferred embodiment of a method of controlling an ejection molding process of an ejection molding machine in the present invention includes an automatic process, of which the setting is performed right after the step of function/time setting as shown in FIG. 9.

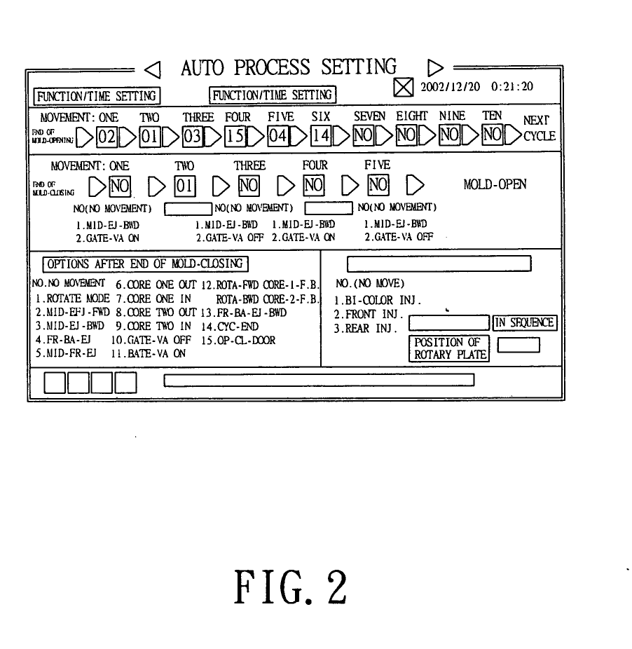

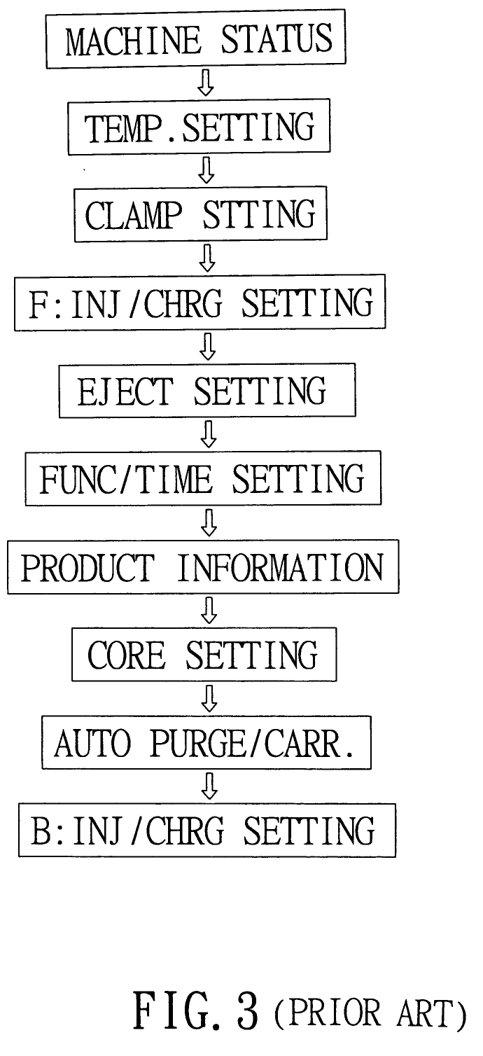

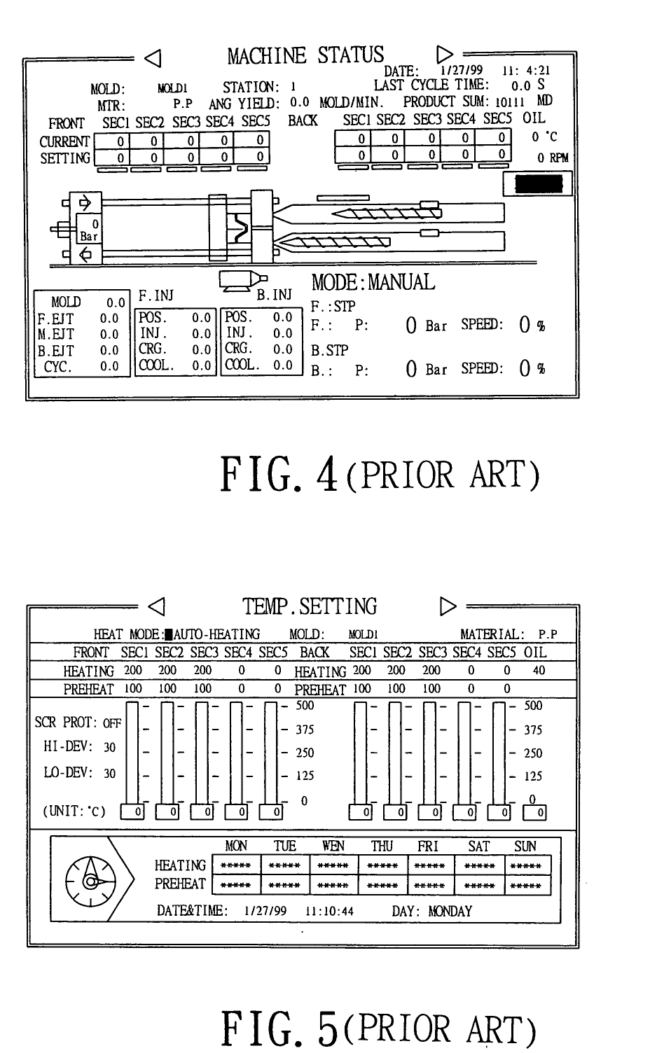

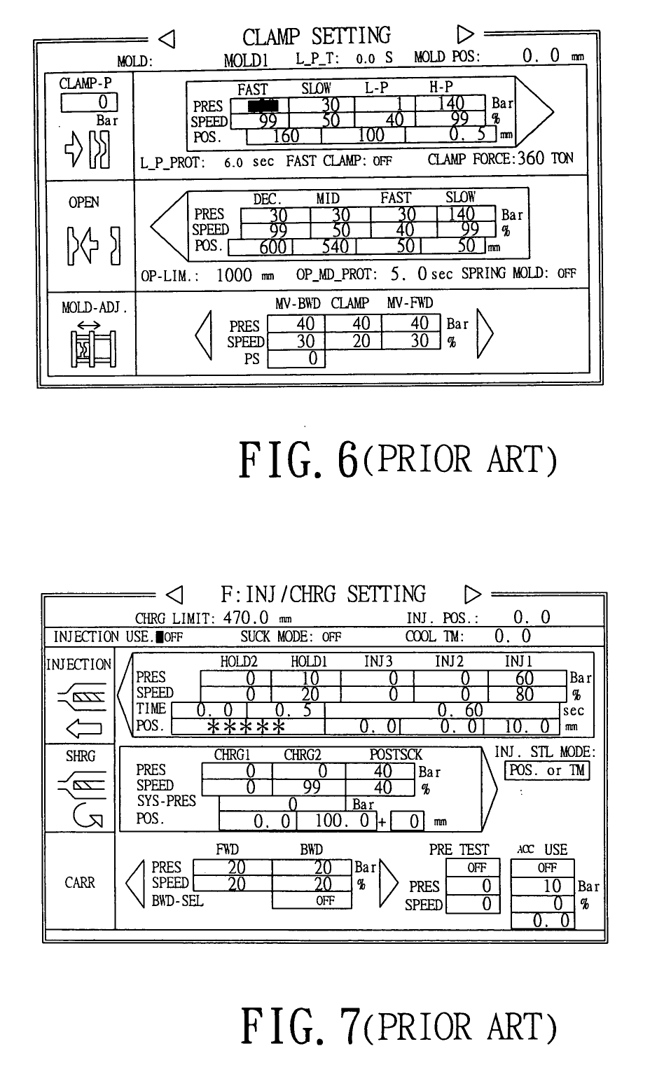

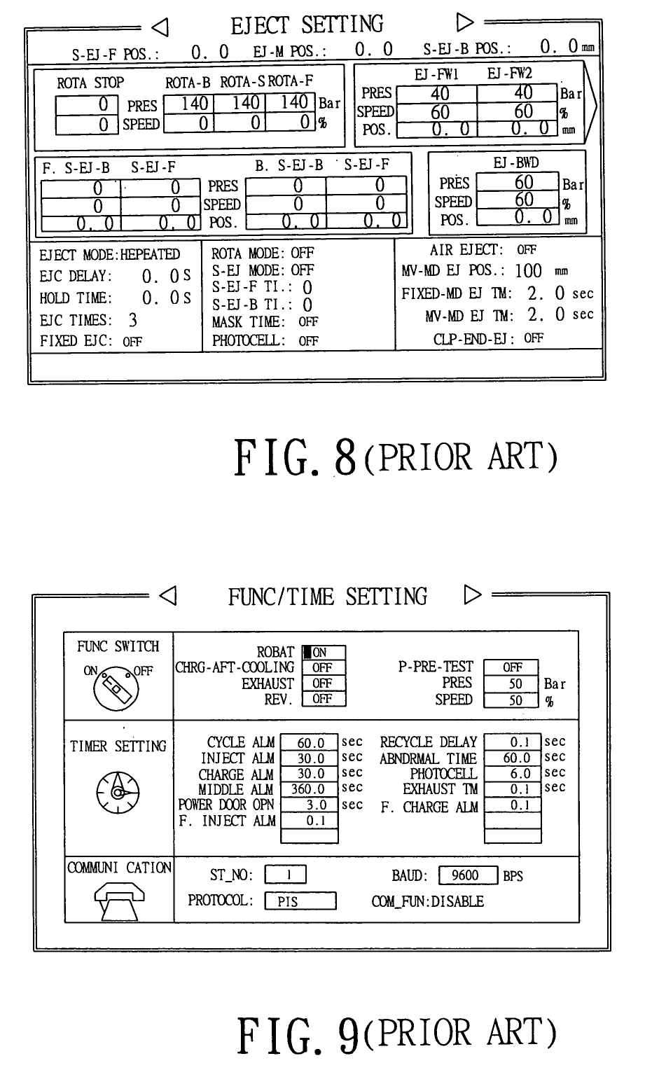

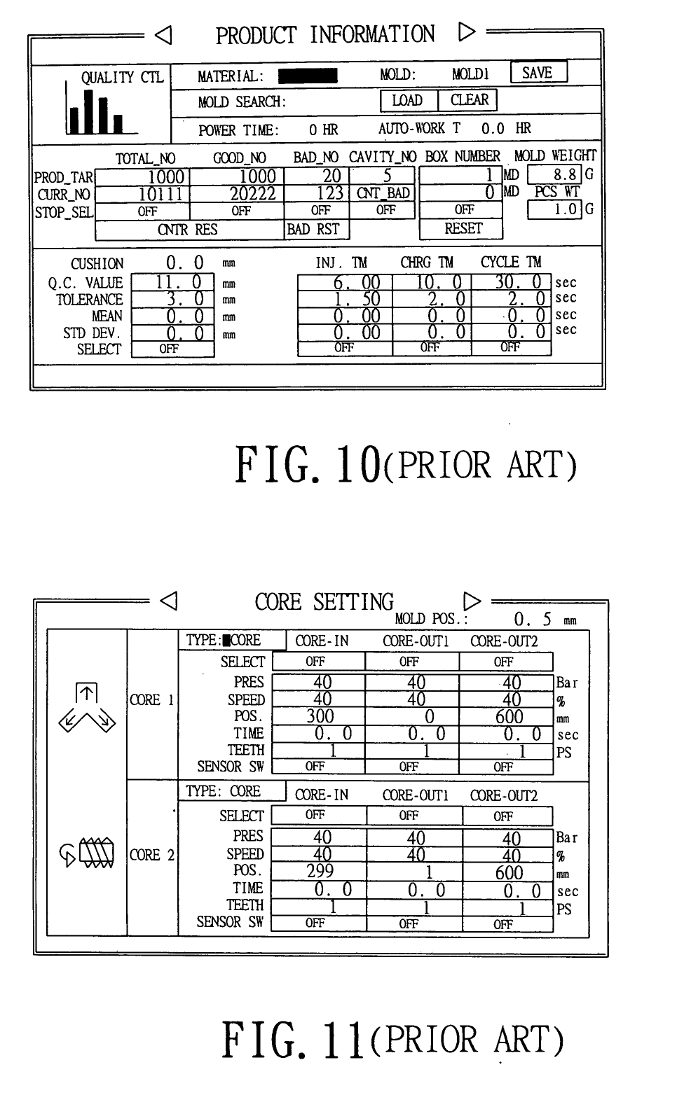

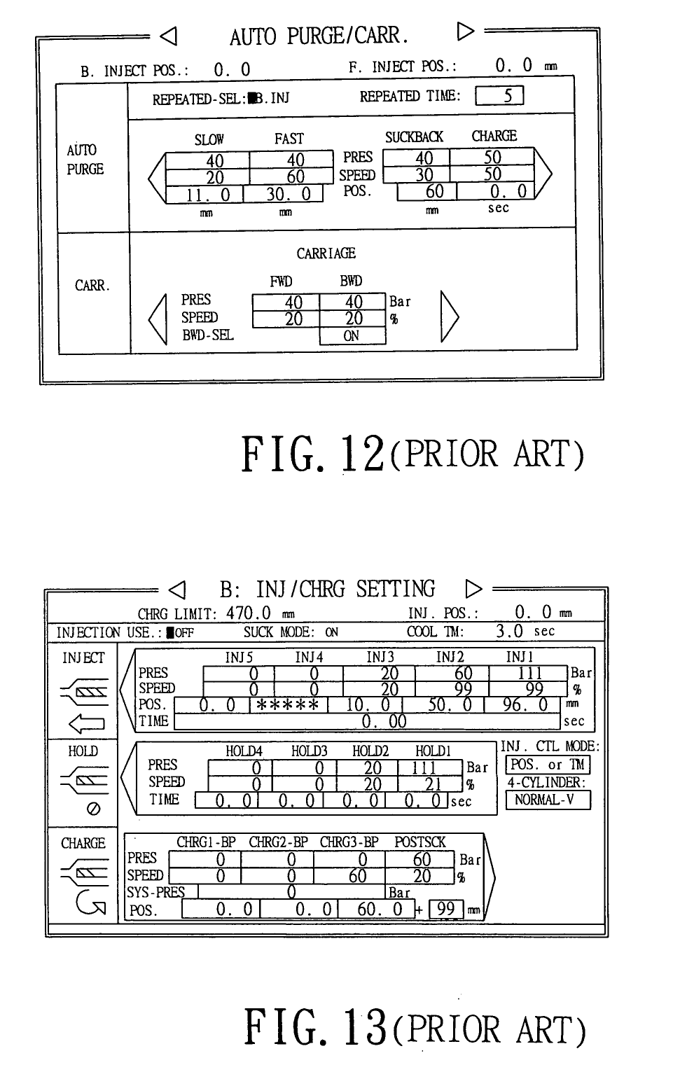

Referring to FIG. 2 plus FIG. 1, the automatic process includes a first part, which includes all actions to be performed after completion of the automatic mold-opening action and before movement of the movable male mold part to a final destination, and a second part, which includes actions to be performed after completion of the automatic mold-closing action and before movement of the movable male mold part to a final destination.

Referring to upper portion of FIG. 2, which is a window shown on the control panel screen for assisting the user with setting of all of the actions; the actions of the first part of the automatic process can be decided in sequence by means of inputting numerals (1 to 15) or “NO” sign onto respective ones of spaces, which are denoted with “movement one”, “movement two”, “movement three” and so on (there are ten spaces provided in the present embodiment, i.e. ten actions can be established at most); brief definitions of the numerals 1 to 15 and the “NO” sign are shown on the left lower portion of the screen, wherein:

“NO” sign means no action;

numeral “1” means “rotate mode”, e.g. when “1” is input onto the second space denoted with “movement two”, a support base of the movable male mold part will rotate accordingly when it is turn of “movement two” to be performed;

numeral “2” means “middle ejector forwards”, e.g. when “2” is input onto the first space denoted with “movement one”, a middle ejector will move forwards to push out a molded product accordingly when it is turn of “movement one” to be performed;

numeral “3” means “middle ejector backwards”, and when “3” is input onto one of the ten spaces, e.g. the third space denoted with “movement three”, the middle ejector will move backwards accordingly when it is turn of “movement three” to be performed; numeral “4” means “front and rear ejectors ejecting”, e.g. when “4” is input onto the fifth space denoted with “movement five”, the front and the rear ejectors will move forwards to push out a molded product accordingly when it is turn of “movement five” to be performed;

numeral “5” means “middle and front ejectors ejecting”, in other words, the middle and the front ejectors will move forwards to push out a molded product accordingly when it is turn of the corresponding movement to be performed;

numeral “6” means “first core out”, in other words, a first core of the mold will move outwardly of the mold accordingly when it is turn of a “movement” set at numeral “6” to be performed;

numeral “7” means “first core in”, in other words, the first core of the mold will move inwardly of the mold accordingly when it is turn of a “movement” to be performed that is set at “7”;

numeral “8” means “second core out”, in other words, a second core of the mold will move outwardly of the mold accordingly when it is turn of a “movement” to be performed that is set at “8”;

numeral “9” means “second core in”, in other words, the second core of the mold will move inwardly of the mold accordingly when it is turn of a “movement” to be performed that is set at “9”;

numeral “10” means “gate valve off”, in other words, a gate valve of the mold will shut accordingly when it is turn of a “movement”, which is set at “10”, to be performed;

numeral “11” means “gate valve on”, in other words, the gate valve of the mold will open accordingly when it is turn of a “movement” that is set at “11” to be performed;

numeral “12” means “rotate forwards, the first core in and out” plus “rotate backwards, the second core in and out”, in other words, the support base of the movable male mold part rotates forwards, and the first core moves in and then moves out while the support base of the movable male mold part rotates backwards, and the second core moves in and then moves out when it is turn of a “movement”, which is set at “12”, to be performed;

numeral “13” means “front and rear ejectors backwards”, in other words, the front and the rear ejectors will move backwards accordingly when it is turn of a “movement” to be performed that is set at “13”;

numeral “14” means “end of cycle”, i.e. end of the first part of the automatic process; and

numeral “15” means “safety door open and close”, in other words, the safety door will open and then shut when it is turn of a “movement” to be performed that is set at “15”.

The actions of the second part of the automatic process can be decided in sequence by means of inputting one numeral or “NO” sign onto respective spaces, which are denoted with “movement one”, “movement two”, “movement three”, “movement four”, and “movement five”, wherein:

there are three options provided for setting “movement one”, which are “NO” (no movement), “1” (middle ejector forwards, i.e. a middle ejector moves forwards to push out a molded product), and “2” (gate valve on, i.e. the gate valve of the mold opens);

there are four major options in setting “movement two”, and “movement four”, which are “NO” (no movement), “1” (two color injection at the same time, i.e. two different color materials are injected into the mold at the same time), “2” (front side injection, i.e. materials are injected through the front side of the mold), and “3” (rear side injection, i.e. materials are injected through the rear side of the mold), as shown on the right lower portion of the screen; in addition to the above major options, there are “forward rotation of the support base of the movable male mold part is performed in sequence? YES/NO” option, and “the support base is fixed in position, YES/NO?” option;

there are five options provided for setting “movement three”, which are “NO” (no movement), “1” (middle ejector backwards, i.e. the middle ejector moves backwards), “2” (gate valve off, i.e. the gate valve of the mold shuts), “3” (middle ejector forwards, i.e. the middle ejector moves forwards to push out a molded product), and “4” (gate valve on, i.e. the gate valve of the mold opens);

there are three options in setting “movement five”, which are “NO” (no movement), “1” (middle ejector backwards, i.e. the middle ejector moves backwards), and “2” (gate valve off, i.e. the gate valve of the mold shuts).

Please refer to the example shown on FIG. 2 for a clearer understanding of the automatic process of the present invention, wherein: “movement one” to “movement ten” of the first part of the automatic process are defined with “02” (middle ejector forwards), “01” (rotate mode), “03” (middle ejector backwards), “15” (safety door open and close), “04” (front and rear ejectors ejecting), “14”(end of cycle), “NO”(no movement), “NO”, “NO”, and “NO” in sequence. Thus, firstly, immediately after the mold opening motion is finished, the middle ejector will push the molded product off the mold, and will action according to the setting of “middle ejector” on the window of “rotate/eject/blowing”, e.g. if the setting of “middle ejector” is “final position”, the middle ejector will move to the final position of the ejection stroke. Then, the support base will rotate; the “use of rotation” column on the window of “rotate/eject/blowing” should be previously set as “ON”. Thirdly, after the support base finishes rotating, the middle ejector will move backwards to the rearmost position (movement three). Afterwards, the safety door is opened, and then shut (movement four). After movement of the safety door, motions of the front and the rear ejectors are carried out according to the setting of “motions of front and rear ejectors” on the window of “rotate/eject/blowing”, e.g. if the setting is “repetition”, the ejectors will move forwards and backwards as many times as the setting, and if front ejector is set as “on”, and rear ejector is set as “no movement”, only will the front ejector action. Finally, the cycle ends (movement six), and a next cycle begins.

Referring to the example shown on FIG. 2 again, “movement one” to “movement five” of the second part of the automatic process are set as “NO”, “1”, “NO”, “NO”, and “NO”; thus, after completion of mold closing operation, bi-color injection will be carried out (movement two), by means of which two materials of different colors will be injected at the same time with two charging tubes; in case “movement one” is set as certain motion instead of “NO”, the motion will be carried out before injection of materials.

The user of the molding machine can move the cursor on a window on the control panel to a column defined as “explanation of setting of process”, and press “enter” key to switch to the window of “explanation of setting of process”.

From the above description, it can be easily understood that the method of the present invention allows the user of a molding machine to easily and conveniently set and change the process of injection molding of the molding machine according to their molds with prepared options for settings without assistance of the manufacturer of the molding machine.

What is claimed is:

1. A method of controlling an ejection molding process of an ejection molding machine, comprising actions of:
monitoring machine status whereby information relating to operation of an injection machine are presented on a control panel;
setting temperature whereby settings relating to control of temperature and heating are done;
setting clamp whereby operations of the machine relating to mold closing, mold opening, and mold adjustment are set respectively;
setting front injection/charging whereby operations of the machine relating to injection, maintenance of pressure, charging of materials are set respectively;
setting pushing/blowing whereby operations of the machine are set that relate to “a middle ejector pushing”, “a support base of a male mold part rotating”, “a front ejector pushing”, “a rear ejector pushing”, and “air blowing”;
setting function/time whereby operations of the machine are respectively set that relate to a function switch, an initial pressure on front side and rear side, and time;
setting data of products whereby data of production, and parameters of quality control of molded products are input respectively;
setting about cores whereby operations of the machine and a mold relating to a plurality of cores are set;
setting auto purge/carriage whereby operations of the machine and the mold are set respectively that relate to position control of front and rear screw rods, and purging of materials;
setting backward injection/charging whereby operations of the machine are set respectively that relate to injection, pressure maintenance, and material charging; and
setting an automatic process; the action of setting an automatic process being right after the action of setting function/time; the setting of an automatic process including:
a first part whereby those motions can be set that are to be performed after completion of the mold-opening action by means of choosing among prepared options provided for setting each motion; and
a second part whereby those motions can be set that are to be performed after completion of the mold-closing action by means of choosing among prepared options provided for setting each motion;
whereby motions of the molding machine and a mold at various stages of an injection molding process can be set and changed according to nature of the mold.

2. The method of controlling an ejection molding process of an ejection molding machine as claimed in claim 1, wherein one of the options provided for setting of motions to be performed after completion of the mold-opening action is “no movement”.

3. The method of controlling an ejection molding process of an ejection molding machine as claimed in claim 1, wherein options provided for setting a first motion to be performed after completion of the mold-closing action include “NO” (no movement), “middle ejector pushing”, and “gate valve on”.

4. The method of controlling an ejection molding process of an ejection molding machine as claimed in claim 1, wherein options provided for setting second and fourth motions to be performed after completion of the mold-closing action include “NO” (no movement), “two color injection at the same time” (two different color materials are injected into the mold at a same time), “front side injection” (materials are injected through a front side of the mold), and “rear side injection” (materials are injected through a rear side of the mold).

5. The method of controlling an ejection molding process of an ejection molding machine as claimed in claim 1, wherein options provided for setting a third motion to be performed after completion of the mold-closing action include “NO” (no movement), “middle ejector backwards” (a middle ejector moves backwards), “gate valve off” (the gate valve shuts), “middle ejector forwards” (the middle ejector moves forwards), and “gate valve on” (the gate valve opens).

6. The method of controlling an ejection molding process of an ejection molding machine as claimed in claim 1, wherein options provided for setting a fifth motion to be performed after completion of the mold-closing action include “NO” (no movement), “middle ejector backwards” (a middle ejector moves backwards), and “gate valve on” (the gate valve opens).
